(19) United States
(12) Patent Application Publication
(10) Pub. No.: US 2016/0105731 A1
(43) Pub. Date: Apr. 14, 2016

(54) SYSTEMS AND METHODS FOR IDENTIFYING AND ACQUIRING INFORMATION REGARDING REMOTELY DISPLAYED VIDEO CONTENT

(71) Applicant: ICCODE, INC., Southlake, TX (US)

(72) Inventors: Rok Ajdnik, Dallas, TX (US); Matija Vrbovsek, Dallas, TX (US)

(21) Appl. No.: 14/719,065

(22) Filed: May 21, 2015

Related U.S. Application Data
(60) Provisional application No. 62/001,576, filed on May 21, 2014.

(51) Int. Cl. H04N 21/84; G06F 17/30; H04N 21/4782; G06K 9/00; H04N 21/858

(52) U.S. Cl. CPC H04N 21/84; G06K 9/00744; H04N 21/8586; H04N 21/4782; G06F 17/30867; G06F 17/30784

(57) ABSTRACT

A computing apparatus, method, and system is provided that enables mobile users to obtain additional information about video content displayed remotely by capturing and analyzing the displayed content. For example, a computing apparatus-implemented method is provided for identifying remotely displayed video content that comprises the steps of acquiring at least one remote image with an image recognition application on a mobile device, extracting recognition data from the at least one remote image, comparing the extracted recognition data to an image database of database images, and matching the at least one remote image to at least one database image.

### CROSS-REFERENCE

This application claims the benefit of U.S. Provisional Patent Application No. 62/001,576, entitled: “SYSTEMS AND METHODS FOR IDENTIFYING AND ACQUIRING INFORMATION REGARDING REMOTELY DISPLAYED VIDEO CONTENT” filed May 21, 2014, the content of which is incorporated by reference in its entirety.

### BACKGROUND

Viewers of video displays would often like to learn more about an article displayed on screen, including article worn by entertainers and actors. But viewers seldom possess sufficient information to learn more about the article. For example, a consumer watching television may wonder what sunglasses an actor is wearing so that the consumer could look into purchasing similar sunglasses. Consumers may benefit from a convenient means of learning more about an article shown in video.

### SUMMARY

The disclosure is directed to a computing apparatus, method, and system that enables mobile users to obtain additional information about video content displayed remotely by capturing and analyzing the displayed content. In particular, the disclosure is directed to a computing apparatus-implemented method of identifying remotely displayed video content that comprises the steps of acquiring at least one remote image with an image recognition application on a mobile device, extracting recognition data from the at least one remote image, comparing the extracted recognition data to an image database of database images, and matching the at least one remote image to at least one database image.

In some aspects, the step of matching includes the mobile device receiving a URL address associated with content related to the at least one remote image. Moreover, the content of the web page identified by the URL address is displayed on the mobile device.

In one embodiment, the disclosure is directed to a computing apparatus having at least one microprocessor and memory storing instructions configured to instruct the at least one microprocessor to perform operations. The computing apparatus includes a video recognition system (e.g. a camera) configured to obtain remotely displayed video and the computing apparatus is configured to store the obtained remotely displayed video. The computing apparatus also includes a module configured to identify images from the video and extract recognition data from the images and is configured to match the extracted recognition data to data identifying at least one database image obtained from or present on a database of database images.

In another embodiment, the disclosure is directed to a system for displaying web content related to remotely displayed video content that comprises a first computing apparatus having at least one microprocessor, display, and memory storing instructions configured to instruct the at least one microprocessor to perform operations. The first computing apparatus comprises a video recognition system (camera) configured to obtain remotely displayed video and is configured to store the obtained remotely displayed video. The first computing apparatus further comprises a module configured to identify images from the video and extract recognition data from the images, wherein the module is configured to match the extracted recognition data to data identifying at least one database image obtained from or present on a database of database images. The system further comprises a second computing apparatus having at least one microprocessor and memory storing instructions configured to instruct the at least one microprocessor to perform operations, and comprises a database of database images and configured to communicate the database images and associated web content to the first computing apparatus. A user can view the associated web content displayed on the first computing apparatus.

### BRIEF DESCRIPTION OF THE DRAWINGS

The above and other features of the present invention, its nature and various advantages will be more apparent upon consideration of the following detailed description, taken in conjunction with the accompanying drawings in which:

FIG. 1A is a schematic diagram of an exemplary but not exclusive system for capturing remotely displayed video content and acquiring additional information practiced in accordance with some embodiments of the invention;

FIG. 1B is a schematic diagram of an exemplary but not exclusive system for cataloging video and creating content for viewing by a mobile device user;

FIG. 2A is a flow diagram of an exemplary but not exclusive method of capturing and processing remotely displayed video;

FIG. 2B is a flow diagram of an exemplary but not exclusive embodiment of the compression process identified in FIG. 2A;

FIG. 3A is a flow diagram of an exemplary but not exclusive method of acquiring content in accordance with the invention;

FIG. 3B is a flow diagram of a hierarchical tree search in accordance with the invention;

FIG. 3C is a flow diagram of a ratio test in accordance with an embodiment of the invention;

FIG. 4A is a flow diagram of an exemplary but not exclusive method for cataloging video using a desktop application configured to run on a computing apparatus in accordance with an embodiment of the invention;

FIG. 4B is a flow diagram of an exemplary but not exclusive method of extracting keyframes in accordance with an embodiment of the invention;

FIG. 5A is a flow diagram of an exemplary but not exclusive method of processing data by an update server in accordance with an embodiment of the invention;

FIG. 5B is a flow diagram of an exemplary but not exclusive method for updating the tree database in accordance with an embodiment of the invention;

FIG. 6 is a flow diagram of an exemplary but not exclusive embodiment of processing of data by a metrics server in accordance with an embodiment of the invention; and

FIG. 7 is a block diagram of an illustrative but not limiting electronic device for performing an application operative for capturing video content displayed remotely and acquiring additional information regarding the video content in accordance with embodiments of the invention as described herein.

### DETAILED DESCRIPTION

Disclosed herein is a computing apparatus, system and method that enables mobile users to acquire additional information about video content displayed remotely on any screen by capturing the displayed video content using a mobile device.

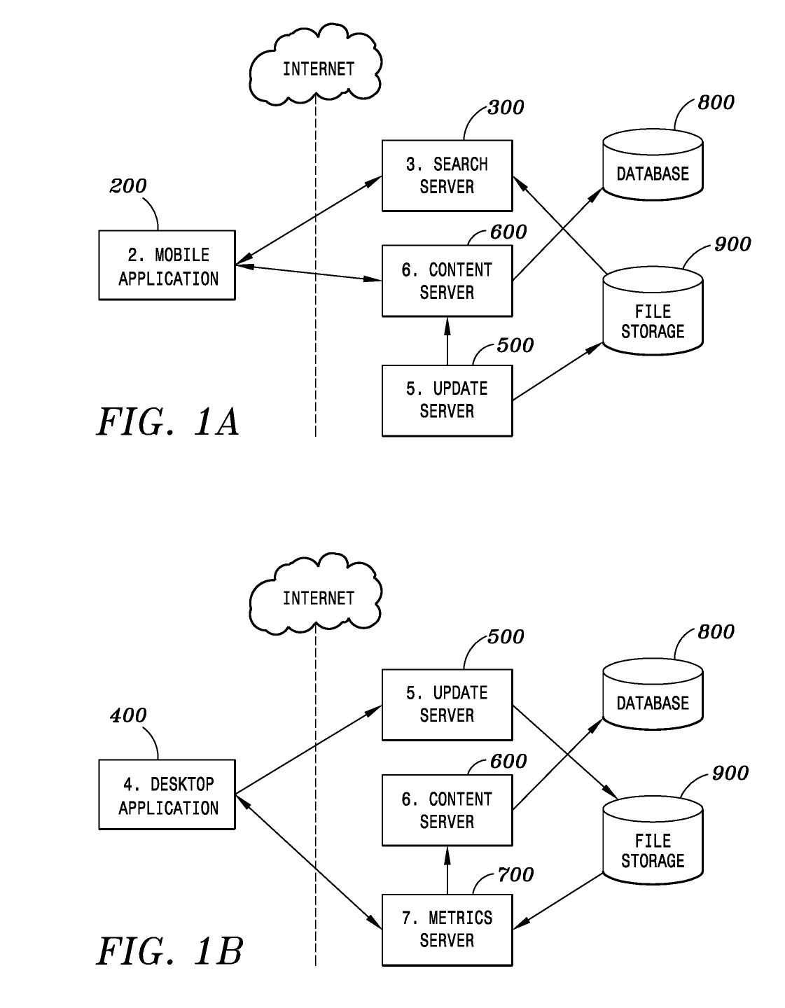

FIG. 1A is a schematic diagram of an exemplary but not exclusive embodiment of the system disclosed herein. Mobile device 200 extracts features from the captured video and compares them to features available on a search server 300. When the data corresponding to the extracted feature is identified a user receives information such as a URL to a webpage stored on a content server 600. The content stored on content server 600 is selected by video providers and can vary through different scenes in a video. Content server is also configured to access content on database 800. An update server 500 may also be included that updates the content on content server 600 as well as store content updates on file storage 900. The first diagram depicts the consumer process including the mobile application and back-end servers supporting the mobile application. The consumer process is the process of video recognition described in the previous paragraph.

FIG. 1B is a schematic diagram of an exemplary but not exclusive embodiment of the system disclosed herein where a desktop application stored on a desktop computing apparatus 400 enables businesses or video providers to catalog the video and create the content that will be displayed on mobile device 200. Desktop computing apparatus 400 is also configured to communicate with metrics server 700.

Referring further to FIG. 1, application of mobile device 200 is used to identify video or particular scene of that video. User points a camera of a mobile phone or any other mobile device towards the screen displaying video content. The screen can be a computer or laptop screen, TV screen, projector or any other screen displaying video content. User holds the device pointed towards the screen until the application recognizes the video content and returns additional information about video content such as a list of products in the video, information about the actors, links to online stores where users can buy those products and other useful information. The mobile application can also include optional registration with existing accounts like Facebook or Gmail. If a user chooses to register we can enrich his experience with personalized web site content such as dynamic advertisement.

The application can run on any mobile device 200 that has a reasonably good camera such as mobile phones or tablet computers. It can also run on any mobile platform such as Android, iOS or any other that enables third party developers to access real-time video feed from the camera.

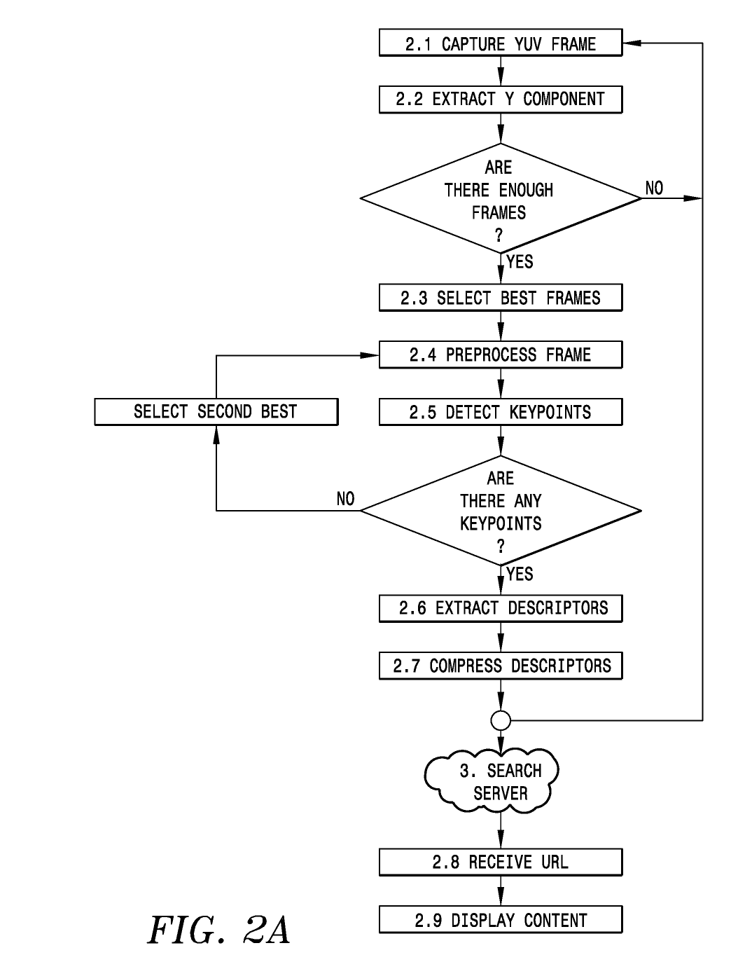

FIG. 2A is a flow diagram of an exemplary but not exclusive embodiment of the method of capturing and processing remotely displayed video.

At step 2.1, YUV frames are captured and natively stored on mobile platforms such as Android or iOS to permit faster to access than converting frames to other color-space representations.

At step 2.2, the Y component is extracted. A gray-scale representation of a video frame is preferred as it is suitable for capturing of YUV frames in step 2.1. The Y component represents the luminance properties of the video frame and is a good approximation of gray-scale representation.

At step 2.3, the best frame is selected from among at least eight captured frames. This technique we can reduce bandwidth needed by 86 percent. Best frames are selected by using a metric such as number of keypoints detected with FAST detector or the sharpness of the frame by observing its frequency distribution using FFT.

At step 2.4, frames are preprocessed. In this step, unsharp masking is used which is an image sharpening technique for better detection of keypoints.

At step 2.5, keypoints are detected. Keypoints are isolated pixels on an image represented so that they are scale and rotation invariant and robust to noise. For detection of keypoints state-of-the-art detectors such as ORB or BRISK are used. In comparison to other detectors such as SIFT and SURF they are faster to compute, which is needed on resource limited mobile platforms to perform real-time video recognition. When there are no keypoints in a camera frame, which happens if frame consists of only homogeneous surface with no texture or corners, the second best frame is selected from those obtained in step 2.3.

At step 2.6, descriptors are extracted. Descriptors are patches around keypoints that uniquely represent them. State-of-the-art binary descriptors, such as BRIEF, ORB, BRISK or FREAK for a fast computation on mobile devices, are used. In comparison to vector descriptors such as SIFT and SURF they are faster to compute and smaller in data size so they can be sent over wireless networks more efficiently.

At step 2.7, descriptors are compressed. Compression of descriptors is beneficial to satisfy the constraints of mobile wireless networks such as 3G-HSPA, 4G-HSPA+ and 4G-LTE. Considering the constraints of real-time video capture which is occurring at 30 frames per second and the average descriptor size per frame which is approximately 256 kilobytes a minimum 61.44 Mbps of bandwidth would be required. Even after the process of step 2.3 is applied, 7.68 Mbps are still needed which may be too big for 3G-HSPA and 4G-HSPA+ networks whose bandwidth limits are at 5.8 Mbps for upload speed. By applying the compression the size of descriptors is decreased by 32 percent which decreases bandwidth need to 5.2 Mbps.

The compression process is shown in FIG. 2B. At step 2.7.1, the most stable descriptor is identified. Mot or all the keypoints of descriptors are reviewed and the most stable is determined by calculating the determinant of Hessian matrix. Hessian matrix contains second-order partial derivatives of x and y coordinates of the keypoint. In some embodiment, the keypoint with the highest Hessian response is selected.

At step 2.7.2, remaining descriptors are sorted. The remaining descriptors are sorted based on the distance between them and begins with the most stable descriptor selected in step 2.7.1 and the descriptor closest to it. The process is repeated for every or at least the majority of the descriptors. As a distance measure, Hamming distance is preferred as it is suitable for binary descriptors.

At step 2.7.3, differential pulse-code modulation (DPCM) coding is employed, which is a method that encodes the difference between two consecutive quantized samples. The difference is encoded using bitwise XOR operation.

At step 2.7.4, binary arithmetic coding is performed. Binary arithmetic coding works in a similar manner as a regular arithmetic coder but does not require prior knowledge of the alphabet and its size. In comparison to arithmetic coding it operates directly on bits instead of bytes. The probability model is initialized at the beginning of the coding process with equal probabilities for the symbols 1 and 0.

Referring back to FIG. 2A, at step 2.8 a URL address is received. After sending compressed descriptors to search server 300, a response is received by mobile device 200 containing URL address. Steps 2.1 through 2.7 continue to be performed. The received URL address links to content server 600.

At step 2.9, content of the web page is displayed via an application browser on the mobile device 200 so that the user can interact with the content.

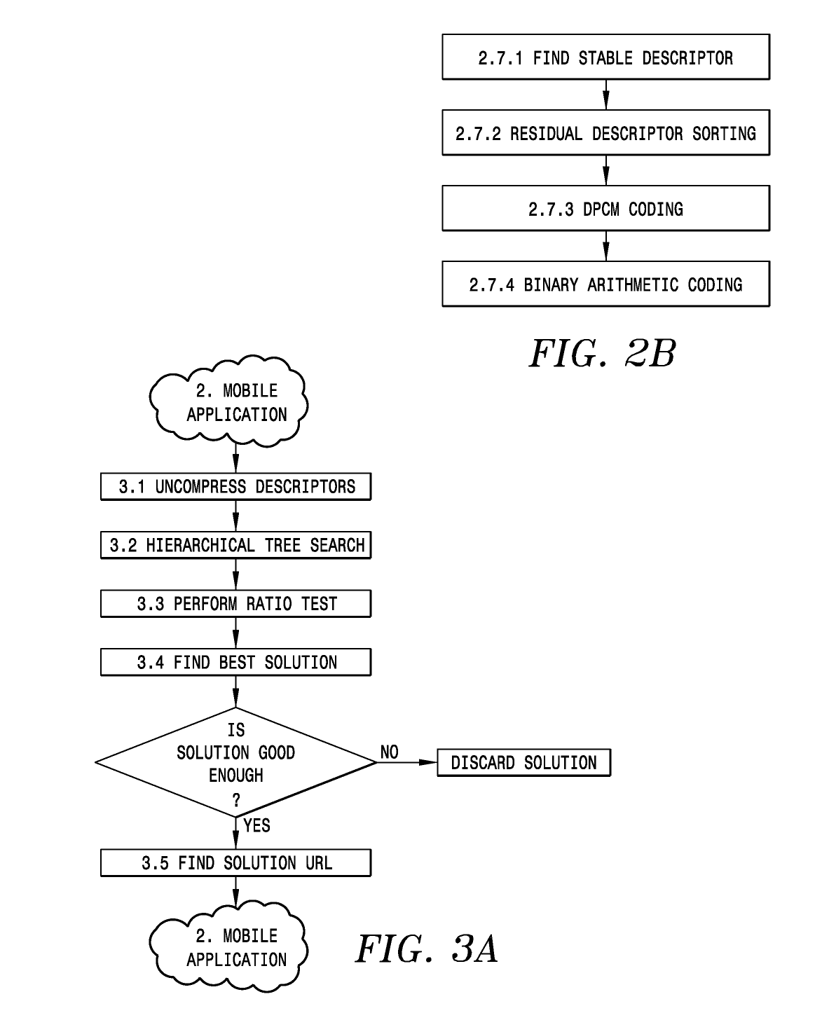

FIG. 3A is a flow diagram of an exemplary but not exclusive embodiment of the search process between mobile device 200 and search server 300. Search server 300 handles requests sent by the mobile application on mobile device 200. Search server 300 is a group of servers managed by a load balancing system so that they can handle large amount of mobile application requests needed for real-time recognition. The search process employs hierarchical tree algorithm to decrease the time needed to find the best match. The algorithm can be implemented on a cluster such as Hadoop which enables a fast search speed to be maintained even with a large number of descriptors. The tree structure is stored on our data storage system as a series of smaller files each containing a subsection of a tree. This is beneficial when clusters are employed for searching. Each server can load a small portion of that tree and search that particular section of the tree. File sizes are small enough so they don't pose any constraints when loading them into memory. To further optimize search the location of the mobile application can be detected and only search through a smaller tree containing only local content available to the user of the mobile application.

At step 3.1, descriptors are uncompressed. After receiving the request from the mobile application via mobile device 200, descriptors are next uncompressed, which is preferably performed by first performing binary arithmetic decoding and then DPCM coding. The process yields a vector of descriptors that may be used in the search.

As step 3.2, a hierarchical clustering tree algorithm uses tree structure and random clusters to represent multidimensional data in a way that it can be searched more efficiently. The algorithm receives one descriptor from a search vector and finds the closest matching descriptor in the tree. For tree branching a random clustering with 32 clusters per tree level is used and stored in a leaf node. In one aspect up to 150 descriptors are stored. The algorithm of D. G. Lowe is applied that uses parallel trees to further speed up the search process as is known in the art.

FIG. 3B is a flow diagram of the hierarchical tree search of step 3.2. At step 3.2.1, multiple trees are used to perform our search. In a preferred aspect, at least four trees are used when searching in parallel but more trees may be added if the amount of data to be searched increases. Because of random clustering there is a significant chance that one of the trees will find a better closest match than others.

At step 3.2.2, leaf nodes are identified. In order to find the closest matches the trees are traversed by calculating the Hamming distance between nodes and the search descriptor.

At step 3.2.3, closest matches are identified. When leaf nodes are identified a linear search is performed across all of the descriptors in the node to find best matches. If a sufficient number of best matches are not identified the search is continued other unvisited tree nodes stored in the priority queue.

At step 3.2.4, matches are consolidated. Matches in all the trees are identified and the best among them is selected.

Referring back to FIG. 3A, at step 3.3 a ratio test is performed, as depicted in more detail in FIG. 3C. A preferred ratio test is the one proposed by David Lowe to determine which of the matches are valid by comparing the similarity between the best and second best solution as is known in the art. Ambiguous solutions and lower the percentage of false positives may be discarded. Referring to FIG. 3C, at step 3.3.1, match pairs are compared. First and second best solutions found for each descriptor in the search vector is compared and if the solutions are similar when comparing the distance they are preferably discarded, as it is unclear whether the best solution is sufficiently accurate. For the similarity test, a threshold of 0.8 is preferably used.

Referring again to FIG. 3A, at step 3.4, the best solution is identified. After the ratio test, frames corresponding to descriptors in the solution vector are identified and the frame that has the most occurrences in the solution vector is selected. A threshold for the number of occurrences may also be applied, so that if the number of occurrences is below a certain threshold the frame may be considered a false positive.

At step 3.5, a solution URL is found. If a good solution is identified a corresponding URL in the database is sent to the mobile application on the mobile device 200. In one aspect, the local time and location of the mobile application user may be identified and a URL with different content dependent on that information may be sent.

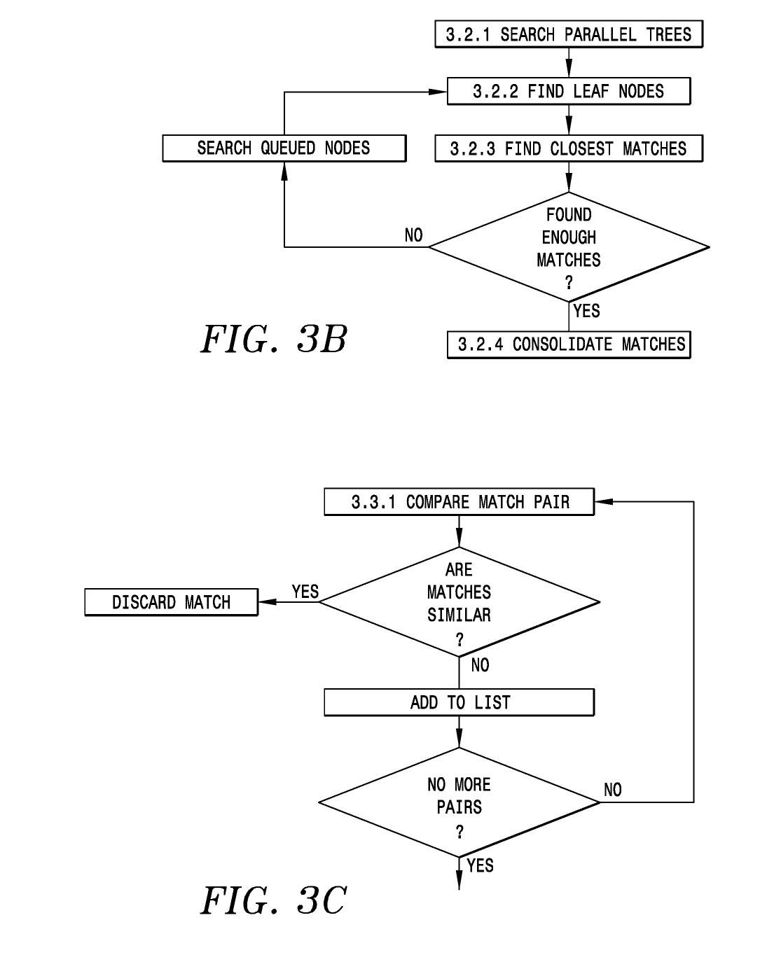

FIG. 4A is a flow diagram of an exemplary but not exclusive embodiment of a method for cataloging video using a desktop application configured to run on the desktop computing apparatus 400. The desktop application is used for cataloging the video. The data acquired through this process is then sent to update server 500. Algorithm for cataloging is platform agnostic and can run on multiple operating systems such as Microsoft Windows, OS X or Linux. It can utilize multiple cores of CPU or GPU to speed up the cataloging process.

At step 4.1, video is loaded. A user selects video for cataloging and application decodes it using the appropriate codec. The solution is preferably independent of different codecs and only requires access to decoded video frames unlike certain solutions that require object data located on particular frames.

At step 4.2, keyframes are extracted, as also shown in further detail in FIG. 4B. Keyframes are used to describe distinct scenes in the video. Each scene in video can be represented by a small number of keyframes, because the image content does not change a lot during a scene so sequential frames have almost identical descriptors. By using a set of keyframes to describe video content the size of bandwidth needed to send cataloging data to the update server is significantly reduced, and in general the size needed to store a single video on the servers is also reduced.

Referring to FIG. 4B, at step 4.2.1 sequential frames are compared and their difference is calculated. This can be achieved by using normalized cross-correlation, absolute difference or comparing their descriptors. When the difference rises above a predetermined threshold one may confidently ascertain that a new scene has been found.

At step 4.2.2, scene keyframes are identified. After the end of one scene and the beginning of a new scene has been determined, keyframes describing the ended scene may be determined, for example, by selecting a minimal number of equidistantly spaced frames that enclose the whole scene. With the method disclosed herein it is believed that eight frames are sufficient to describe a scene, although more or fewer may be used.

At step 4.2.3, keyframes are consolidated. When keyframes for each scene are obtained then scenes are compared to remove repeating scenes.

Referring back to FIG. 4A, at step 4.3 keypoints are detected as described in step 2.5 and extracted.

At step 4.4, descriptors are extracted such as detailed in step 2.6.

At step 4.5, keyframe metrics are computed to provide feedback to the user. Two metrics are combined into an easily understandable rating system that informs the user how well the keyframes can be recognized by the mobile application. Keyframe sharpness is calculated using techniques described in step 2.3. This provides information regarding how well keypoints may be detected and to remove keyframes with unsatisfying result of the sharpness metric. Remaining descriptors are then sent to metrics server 700 which is able to provide feedback whether there are similar frames stored in the search tree. Similar frames are removed from current keyframe selection.

At step 4.6, the user has the ability to define the scene content presented on the mobile device 200 by content server 600. The user can define unique content for different scenes. Content can also be different based on geographical location or time of mobile application user.

At step 4.7, cataloging data such as keyframes, descriptors and user defined content are then compressed. For compression general-purpose lossless methods are used such as DEFLATE or bzip2. Compressed data is sent to update server 500.

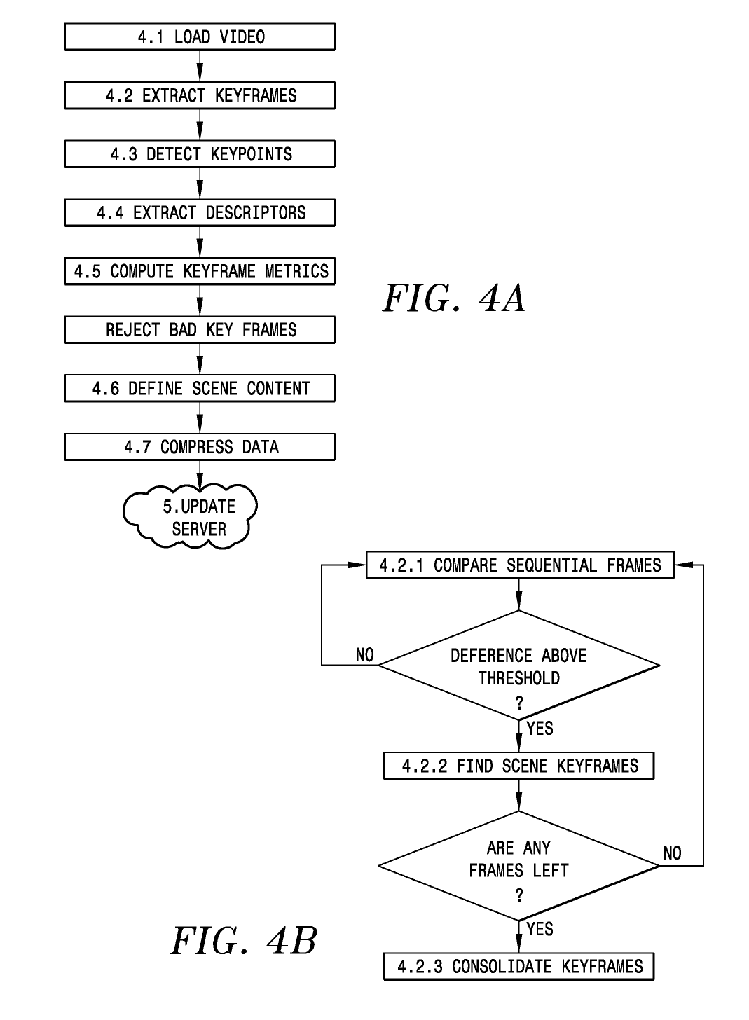

FIG. 5A is a flow diagram of an exemplary but not exclusive embodiment of processing of data by an update server. By way of example, update server 500 handles requests sent by the desktop computing apparatus 400 and updates the tree structure described in steps 3.2 (and substeps 3.2.1 through 3.2.4 and shown in FIGS. 3A and 3B). It is a group of servers managed by a load balancing system so that they can handle large amount of desktop application requests.

At step 5.1, data received from the desktop computing apparatus 400 are uncompressed using a method chosen in step 4.7. Uncompressed keyframes are then archived in case of future algorithm changes, so that the search data structure can be updated.

At step 5.2, uncompressed user defined content is then used to generate a web site. The website may be generated by modifying a preset HTML/CSS/Javascript template and uploading the website and its images to content server 600.

At step 5.3, the hierarchical tree structure is described in detail in step 3.2 (including substeps 3.2.1 through 3.2.4 and shown in FIGS. 3A and 3B). The updating process adds the uncompressed descriptors into the existing tree structures as shown in FIG. 5B. In one aspect the trees are updated one descriptor at a time.

Referring to FIG. 5B, at step 5.3.1, all trees are traversed using the same process as described in step 3.2 (including substeps 3.2.1 through 3.2.4 and shown in FIGS. 3A and 3B). When the closest matching leaf node is identified the new descriptor is inserted into the parent node.

At step 5.3.2, random clusters are created. If there are already a maximum number of leaf nodes in that parent node a new set of random clusters (e.g., 32) are created and those leaf nodes are ordered into clusters based on Hamming distance. The descriptor is then inserted into the closest cluster.

In further regard to content server 600, it distributes web sites to mobile applications running on mobile device 200. Web site content is dynamic and it depends on the user's gender, date of birth, geographic location or other information. In that way a user's experience may be personalized. It uses a group of servers running technologies such as Apache or nginx behind a load balancing system to handle requests sent by mobile application users. It can use a technology such as a content distribution network to distribute that content to users faster and with lower latencies by employing caching technologies. The system is horizontally scalable to handle larger number of requests or larger amount of web site content.

In further regard to metrics server 700, metrics server 700 assists the desktop application in evaluating keyframes and provides information regarding which keyframes are unique enough to be recognized. The structure is similar to search server 300 and could be integrated in search server which would provide response according to the request context. If a request would be made from a mobile application search server would return URL otherwise it would return metrics results.

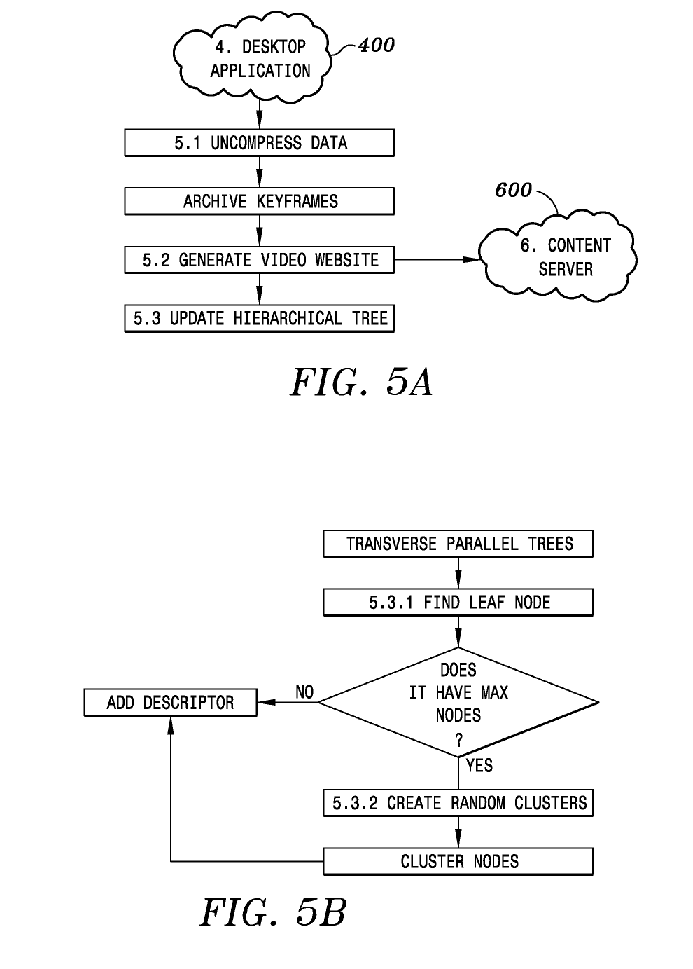

FIG. 6 is a flow diagram of an exemplary but not exclusive embodiment of processing of data by an metrics server 700.

At step 7.1, the best solution is identified. A solution search is performed in the same manner as in the searching process described with respect to FIGS. 3A and 3B. If a descriptor is too similar to existing ones it receives a low rating.

At step 7.2, results are consolidated. Ratings of all descriptors are consolidated into a single result vector that gets compressed and sent to the desktop application running on the desktop computing apparatus 400.

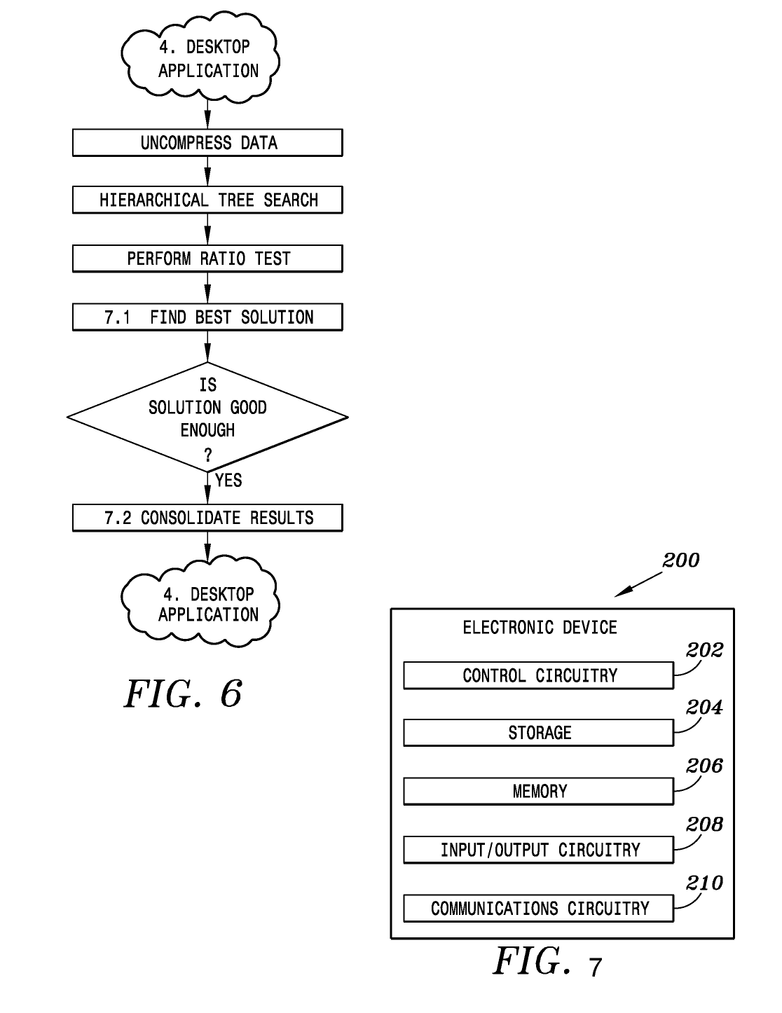

FIG. 7 is a block diagram of an illustrative but not limiting electronic device for performing an application operative for capturing video content displayed remotely and acquiring additional information regarding the video content in accordance with embodiments of the invention as described herein. Electronic device 200 can include control circuitry 202, storage 204, memory 206, input/output (“I/O”) circuitry 208, and communications circuitry 210. In some embodiments, one or more of the components of electronic device 200 can be combined or omitted (e.g., storage 204 and memory 206 may be combined). In some embodiments, electronic device 200 can include other components not combined or included in those shown in FIG. 7 (e.g., motion detection components, a power supply such as a battery or kinetics, a display, bus, a positioning system, a camera, an input mechanism, etc.), or several instances of the components shown in FIG. 7. For the sake of simplicity, only one of each of the components is shown in FIG. 7.

Electronic device 200 can include any suitable type of electronic device. For example, electronic device 200 can include a portable electronic device that the user may hold in his or her hand, such as a smartphone (e.g., an iPhone made available by Apple Inc. of Cupertino, Calif. or an Android device such as those produced and sold by Samsung). As another example, electronic device 200 can include a larger portable electronic device, such as a tablet or laptop computer. As yet another example, electronic device 200 can include a substantially fixed electronic device, such as a desktop computer.

Control circuitry 202 can include any processing circuitry or processor operative to control the operations and performance of electronic device 200. For example, control circuitry 202 can be used to run operating system applications, firmware applications, media playback applications, media editing applications, or any other application. In some embodiments, control circuitry 202 can drive a display and process inputs received from a user interface.

Storage 204 can include, for example, one or more storage mediums including a hard-drive, solid state drive, flash memory, permanent memory such as ROM, any other suitable type of storage component, or any combination thereof. Storage 204 can store, for example, media data (e.g., music and video files), application data (e.g., for implementing functions on electronic device 200), firmware, user preference information data (e.g., media playback preferences), authentication information (e.g. libraries of data associated with authorized users), lifestyle information data (e.g., food preferences), exercise information data (e.g., information obtained by exercise monitoring equipment), transaction information data (e.g., information such as credit card information), wireless connection information data (e.g., information that can enable electronic device 200 to establish a wireless connection), subscription information data (e.g., information that keeps track of podcasts or television shows or other media a user subscribes to), contact information data (e.g., telephone numbers and email addresses), calendar information data, and any other suitable data or any combination thereof

Memory 206 can include cache memory, semi-permanent memory such as RAM, and/or one or more different types of memory used for temporarily storing data. In some embodiments, memory 206 can also be used for storing data used to operate electronic device applications, or any other type of data that can be stored in storage 204. In some embodiments, memory 206 and storage 204 can be combined as a single storage medium.

I/O circuitry 208 can be operative to convert (and encode/decode, if necessary) analog signals and other signals into digital data. In some embodiments, I/O circuitry 208 can also convert digital data into any other type of signal, and vice-versa. For example, I/O circuitry 208 can receive and convert physical contact inputs (e.g., from a multi-touch screen), physical movements (e.g., from a mouse or sensor), analog audio signals (e.g., from a microphone), or any other input. The digital data can be provided to and received from control circuitry 202, storage 204, memory 206, or any other component of electronic device 200. Although I/O circuitry 208 is illustrated in FIG. 7 as a single component of electronic device 200, several instances of I/O circuitry 208 can be included in electronic device 200.

Electronic device 200 can include any suitable interface or component for allowing a user to provide inputs to I/O circuitry 208. For example, electronic device 200 can include any suitable input mechanism, such as for example, a button, keypad, dial, a click wheel, or a touch screen. In some embodiments, electronic device 200 can include a capacitive sensing mechanism, or a multi-touch capacitive sensing mechanism.

In some embodiments, electronic device 200 can include specialized output circuitry associated with output devices such as, for example, one or more audio outputs. The audio output can include one or more speakers (e.g., mono or stereo speakers) built into electronic device 200, or an audio component that is remotely coupled to electronic device 200 (e.g., a headset, headphones or earbuds that can be coupled to communications device with a wire or wirelessly).

In some embodiments, I/O circuitry 208 can include display circuitry (e.g., a screen or projection system) for providing a display visible to the user. For example, the display circuitry can include a screen (e.g., an LCD screen) that is incorporated in electronics device 200. As another example, the display circuitry can include a movable display or a projecting system for providing a display of content on a surface remote from electronic device 200 (e.g., a video projector). In some embodiments, the display circuitry can include a coder/decoder (CODEC) to convert digital media data into analog signals. For example, the display circuitry (or other appropriate circuitry within electronic device 200) can include video CODECs, audio CODECs, or any other suitable type of CODEC.

The display circuitry also can include display driver circuitry, circuitry for driving display drivers, or both. The display circuitry can be operative to display content (e.g., media playback information, application screens for applications implemented on the electronic device, information regarding ongoing communications operations, information regarding incoming communications requests, or device operation screens) under the direction of control circuitry 202. Alternatively, the display circuitry can be operative to provide instructions to a remote display.

Communications circuitry 210 can include any suitable communications circuitry operative to connect to a communications network and to transmit communications (e.g., voice or data) from electronic device 200 to other devices within the communications network. Communications circuitry 210 can be operative to interface with the communications network using any suitable communications protocol such as, for example, Wi-Fi (e.g., a 802.11 protocol), Bluetooth., radio frequency systems (e.g., 900 MHz, 1.4 GHz, and 5.6 GHz communication systems), infrared, GSM, GSM plus EDGE, CDMA, LTE and other cellular protocols, VOIP, or any other suitable protocol.

In some embodiments, communications circuitry 210 can be operative to create a communications network using any suitable communications protocol. For example, communications circuitry 210 can create a short-range communications network using a short-range communications protocol to connect to other devices. For example, communications circuitry 210 can be operative to create a local communications network using the Bluetooth protocol to couple electronic device 200 with a Bluetooth headset.

Electronic device 200 can include one more instances of communications circuitry 210 for simultaneously performing several communications operations using different communications networks, although only one is shown in FIG. 7 to avoid overcomplicating the drawing. For example, electronic device 200 can include a first instance of communications circuitry 210 for communicating over a cellular network, and a second instance of communications circuitry 210 for communicating over Wi-Fi or using Bluetooth. In some embodiments, the same instance of communications circuitry 210 can be operative to provide for communications over several communications networks.

In some embodiments, electronic device 200 can be coupled a host device for data transfers, synching the communications device, software or firmware updates, providing performance information to a remote source (e.g., providing riding characteristics to a remote server) or performing any other suitable operation that can require electronic device 200 to be coupled to a host device. Several electronic devices 200 can be coupled to a single host device using the host device as a server. Alternatively or additionally, electronic device 200 can be coupled to several host devices (e.g., for each of the plurality of the host devices to serve as a backup for data stored in electronic device 200).

As mentioned above regarding FIGS. 2A and 2B, in some embodiments an electronic device (e.g., electronic device 200 of FIG. 7) may include an integrated application operative to capture remotely displayed video content and extract information for matching captured images to known images.

The processes discussed above are intended to be illustrative and not limiting. Persons skilled in the art will appreciate that steps of the process discussed herein can be omitted, modified, combined, or rearranged, and any additional steps can be performed without departing from the scope of the invention.

The application can be implemented by software, but can also be implemented in hardware or a combination of hardware and software. The invention can also be embodied as computer-readable code on a computer-readable medium. The computer-readable medium can include any data storage device that can store data which can thereafter be read by a computer system. Examples of the computer readable medium include read-only memory (“ROM”), random-access memory (“RAM”), CD-ROMs, DVDs, magnetic tape, optical data storage device, flash storage devices, or any other suitable storage devices. The computer-readable medium can also be distributed over network coupled computer systems.

Insubstantial changes from the claimed subject matter as viewed by a person with ordinary skill in the art, now known or later devised, are expressly contemplated as being equivalently within the scope of this disclosure. Therefore, obvious substitutions now or later known to one with ordinary skill in the art are defined to be within the scope of the defined elements.

The above-described embodiments of the present invention are presented for purposes of illustration and not of limitation.

What is claimed is:

1. A computing apparatus-implemented method of providing a URL to information about an object observed in a video to a viewer of said video comprising the steps of:
detecting at least one keypoint inherent in a video by recognition of said keypoint on a mobile device;
correlating said keypoint with signature of an object in said video;
identifying said signature in a database of signatures correlating signatures or respective objects with a URL;
transmitting said URL to said mobile device.

2. The computing apparatus-implemented method of claim 1, wherein at least one keypoint is an identifiable pixel inherent in said video.

3. The computing apparatus-implemented method of claim 1, wherein content of a web page identified by said URL address is displayed on the mobile device.

4. A computing apparatus having at least one microprocessor and memory storing instructions configured to instruct the at least one microprocessor to perform operations, the computing apparatus comprising:
a video recognition system (camera) configured to obtain remotely displayed video, wherein the computing apparatus is configured to store the obtained remotely displayed video;
a module configured to identify images from the video and extract recognition data from the images, wherein the module is configured to match the extracted recognition data to data identifying at least one database image obtained from or present on a database of database images.

5. A system for displaying web content related to remotely displayed video content, comprising:
a first computing apparatus having at least one microprocessor, display, and memory storing instructions configured to instruct the at least one microprocessor to perform operations, the first computing apparatus comprising:
a video recognition system configured to obtain remotely displayed video, wherein the computing apparatus is configured to store the obtained remotely displayed video;
a module configured to identify images from the video and extract recognition data from the images, wherein the module is configured to match the extracted recognition data to data identifying at least one database image obtained from or present on a database of database images;
a second computing apparatus having at least one microprocessor and memory storing instructions configured to instruct the at least one microprocessor to perform operations, the second computing apparatus comprising a database of database images and configured to communicate the database images and associated web content to the first computing apparatus;
wherein a user can view the associated web content displayed on the first computing apparatus.

6. A computing apparatus having at least one microprocessor and memory storing instructions configured to instruct the at least one microprocessor to perform operations, the computing apparatus comprising:
a video recognition system (camera) configured to obtain remotely displayed video, wherein the computing apparatus is configured identify at least one keypoint inherent in said video;
a module configured to match the keypoint with a signature of an image in said video correlated with said keypoint;
a module configured to identify a URL associated with said image.

7. A system for displaying web content related to remotely displayed video content, comprising:
a first computing apparatus having at least one microprocessor, display, and memory storing instructions configured to instruct the at least one microprocessor to perform operations, the first computing apparatus comprising:
a video recognition system configured to obtain remotely displayed video, wherein the computing apparatus is configured to store the obtained remotely displayed video;
a module configured to identify at least one keypoint from the video and extract recognition data from the images, wherein the module is configured to match the extracted recognition data to data identifying at least one database image obtained from or present on a database of database images;
a second computing apparatus having at least one microprocessor and memory storing instructions configured to instruct the at least one microprocessor to perform operations, the second computing apparatus comprising a database of database images and configured to communicate the database images and associated web content to the first computing apparatus;
wherein a user can view the associated web content displayed on the first computing apparatus.

8. A computing apparatus-implemented method of identifying remotely displayed video content, comprising the steps of:
acquiring at least one remote image with an image recognition application on a mobile device;
extracting recognition data from said at least one remote image;
comparing the extracted recognition data to an image database of database images; and
matching the at least one remote image to at least one database image.
